(19) United States
(12) Patent Application Publication
(10) Pub. No.: US 2025/0227041 A1
(43) Pub. Date: Jul. 10, 2025

(54) UE, Network Nodes and Methods for Handling Quality of Experience Configurations

(71) Applicant: Telefonaktiebolaget LM Ericsson (publ), Stockholm (SE)

(72) Inventors: Cecilia Eklöf, Täby (SE); Mattias Bergström, Sollentuna (SE); Luca Lunardi, Genoa (IT); Ali Parichehrehteroujeni, Linköping (SE); Filip Barac, Huddinge (SE); Johan Rune, Lidingö (SE)

(21) Appl. No.: 18/703,108

(22) PCT Filed: Oct. 21, 2022
(86) PCT No.: PCT/SE2022/050965

§ 371 Date: Apr. 19, 2024

Related U.S. Application Data
(60) Provisional application No. 63/270,288, filed on Oct. 21, 2021.

(51) Int. Cl. H04L 41/5067; H04W 36/08; H04W 76/19; H04W 76/20

(52) U.S. Cl. CPC H04L 41/5067; H04W 36/08; H04W 76/19; H04W 76/20

(57) ABSTRACT

A method performed by a user equipment for handling Quality of Experience (QoE) configurations is provided. The user equipment receives (VV102), from a network node, a message including a request for full configuration. The user equipment sends (VV104) one or more Attention (AT) commands from the Radio Resource Control, RRC, layer of the user equipment (120) to the application layer of the user equipment. The AT command includes at least one of: an indication to release all QoE configurations in the initial set following a mobility event, an indication to not release any of the initial set of QoE configurations following a mobility event, or an indication to set the initial set of QoE configurations on hold, a list of QoE configuration identifiers corresponding to one or more QoE configurations to be released by the user equipment following a mobility event. The AT command further includes a list of QoE configuration identifiers corresponding to one or more QoE configurations to be retained by the user equipment following a mobility event if the received message includes the list of QoE configuration identifiers. The user equipment performs (VV106) one of the following based on the one or more AT commands: —setting the initial set of QoE configurations on hold in the application layer, —retaining the initial set of QoE configurations in the application layer; and —releasing one or more QoE configurations in the initial set of QoE configurations.

### TECHNICAL FIELD

Embodiments herein relate to a User Equipment (UE), a source network node, a target network node, and methods therein. In some aspects, they relate to handling Quality of Experience (QoE) configurations.

### BACKGROUND

### QoE Measurements in Legacy Solution

Quality of Experience (QoE) measurements have been specified for Long Term Evolution (LTE) and Universal Mobile Telecommunications System (UMTS) and it is being specified for New Radio (NR). The purpose of the application layer measurements is to measure the end user experience when using certain applications. Currently QoE measurements for streaming services and for MTSI (Mobility Telephony Service for Internet Protocol (IP) Multimedia Subsystem (IMS)) services are supported.

The solutions in LTE and UMTS are similar with the overall principles as follows. Quality of Experience Measurement Collection enables configuration of application layer measurements in the user equipment (UE) and transmission of QoE measurement result files by means of Radio Resource Control (RRC) signaling. Application layer measurement configuration received from Operation and Maintenance (O&M) or Core Network (CN) is encapsulated in a transparent container, which is forwarded to UE in a downlink RRC message. Application layer measurements received from UE's higher layer are encapsulated in a transparent container and sent to network in an uplink RRC message. The result container is forwarded to a Trace Collector Entity (TCE).

In 3GPP release 17 a study item for “Study on NR QoE management and optimizations for diverse services” for NR has been carried out. Purpose of the study item was to study solutions for QoE measurements in NR. QoE management in NR will not just collect the experience parameters of streaming services but also consider the typical performance requirements of diverse services (e.g. augmented reality (AR), virtual reality (VR), and ultra-reliable low latency communications (URLLC)).

The measurements may be initiated towards Radio Access Network (RAN) in management-based manner, i.e. from an O&M node in a generic way e.g. for a group of UEs, which may be selected by the RAN, or they may also be initiated in a signaling-based manner, i.e. initiated from CN (on request from the O&M system) to RAN e.g. for a single specific UE. The configuration of the measurement includes the measurement details, which is encapsulated in a container that is transparent to RAN.

When initiated via the core network, the measurement is started towards a specific UE. For the LTE case, the “TRACE START” S1AP message is used, which carries, among others, the details about the measurement configuration the application should collect (in the “Container for application layer measurement configuration” IE, transparent to the RAN) and the details to reach the trace collection entity to which the measurements should be sent. Notifications of started and stopped application sessions with associated QoE measurement configurations are introduced, where these notifications are conveyed from the application layer in the UE and to the UE Access Stratum (i.e. the radio layers in the UE) and then forwarded to the network. This allows the network (at least the RAN) to be aware of when QoE measurements on an application session are ongoing. It is an implementation decision when the RAN stops the measurements. Typically, it is done when the UE has moved outside the configured area for measurement (also referred to as the area scope). However, this strategy is questioned by the desire to have QoE data that represent complete application sessions.

FIG. 1 is a Signaling diagram illustrating the basic signaling (without showing all details) involved in QoE measurement configuration, from the O&M system to the UE. The diagram and describing text below are copy of a diagram and text in 3GPP TS 28.405 v16.0.0 labeled “Figure 4.2.1-1: QMC activation and reporting in LTE”. The signaling diagram in FIG. 1 provides an overview (without showing all the details) of the signaling involved in QoE measurement configuration, from the O&M system to the UE.
1. The Network Management (NM) sends activateAreaQMCJob to Domain management (DM)/Element Management (EM) that controls the impacted eNB(s), and includes the parameters: serviceType, areaScope, qoECollectionEntityAddress, pLMNTarget, qoETarget, qoEReference and QMC configuration file.
2. The DM/EM forwards activateAreaQMCJob to impacted eNB(s), and includes the parameters: serviceType, areaScope, qoECollectionEntityAddress, pLMNTarget, qoETarget, qoEReference and QMC configuration file.
3. The eNB checks for connections where the UE has the UE capability that match the criteria for serviceType in the activateAreaQMCJob.
4. When a connection is found that has the wanted UE capability, the eNB starts a UE request session and stores the associated QoECollectionEntityAddress, sends the message RRCConnectionReconfiguration to the UE, and includes the following: serviceType, qoEReference and QMC configuration file.
5. The access stratum in the UE sends the AT command +CAPPLEVMC to application level and includes the following: serviceType, qoEReference and QMC configuration file.
6. When the application in the serviceType starts, the QMC is initiated.
7. The application layer sends the AT command +CAPPLEVMR including a recording session indication that indicates that a session is started to the access stratum.
8. The UE sends the message MeasReportAppLayer including the recording session indication to the eNB.
9. The eNB sends a notification including the recording session indication to the NM.
10. When the QMC is completed, the recorded information is collected in a QMC report, including qoEReference and recordingSessionId. The qoEReference, Client Id and in the reporting container (that represent the UE request session), and recordingSessionId are needed in the QMC collection entity for post processing purposes.
11. The application layer sends the AT command +CAPPLEVMR including qoEReference and the QMC report to the access stratum.
12. The UE sends the message MeasReportAppLayer including qoEReference and the QMC report to the eNB. 13. The eNB sends the QMC report to the Measurement Collector Entity (MCE) associated to the qoEReference.

One opportunity provided by legacy solution is also to be able to keep the QoE measurement for the whole application session, even during handover situation, so that reported QoE measurement data cover complete application sessions.

### QoE Measurement in Evolved Universal Terrestrial Radio Access Network (E-UTRAN)

### E-UTRAN—Application Layer Measurement Capabilities

For E-UTRAN, the UE capability transfer is used to transfer UE radio access capability information from the UE to E-UTRAN.

### FIG. 2: Illustrates UE Capability Transfer—E-UTRAN.

The UE-EUTRA-Capability information element (IE) is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the UE-EUTRA-Capability-v1530 IE which can be used by the UE to indicate whether the UE supports or not QoE Measurement Collection for streaming services and/or MTSI services, as detailed in the “MeasParameters-v1530” IE encoding below.

The contribution CR 4297 (R2-2004624) for 3GPP TS 36.331 v16.0.0 at the 3GPP TSG RAN2 Meeting #110 proposed an extension of the “UE-EUTRA-Capability” IE that, within the “UE-EUTRA-Capability-v16xy” IE may include a “measParameters-v16xy” IE comprising the qoe-Extensions-r16 IE. The qoe-Extensions-r16 IE may be used to indicate whether the UE supports the release 16 extensions for QoE Measurement Collection, i.e. if the UE supports more than one QoE measurement type at a time and if the UE supports the signaling of withinArea, sessionRecordingIndication, qoe-Reference, temporaryStopQoE and restartQoE.

### E-UTRAN-Application Layer Measurement Reporting

The purpose of the “Application layer measurement reporting” procedure described in 3GPP TS 36.331 and shown below is to inform E-UTRAN about application layer measurement report.

### FIG. 3 Shows Application Layer Measurement Reporting in E-UTRAN

A UE capable of application layer measurement reporting in RRC_CONNECTED may initiate the procedure when configured with application layer measurement, i.e. when measConfigAppLayer has been configured by E-UTRAN.

Upon initiating the procedure, the UE shall:
if configured with application layer measurement, and SRB4 is configured, and the UE has received application layer measurement report information from upper layers:
set the measReportAppLayerContainer in the MeasReportAppLayer message to the value of the application layer measurement report information;
set the serviceType in the MeasReportAppLayer message to the type of the application layer measurement report information;
2> submit the MeasReportAppLayer message to lower layers for transmission via SRB4.

### E-UTRAN-QoE Measurement Configuration Setup and Release-RRC Signaling

The RRCConnectionReconfiguration message is used to reconfigure the UE to setup or release the UE for Application Layer measurements. This is signaled in the measConfigAppLayer-15 IE within the “OtherConfig” IE.

The setup includes the transparent container measConfigAppLayerContainer which specifies the QoE measurement configuration for the Application of interest and the serviceType IE to indicates the Application (or service) for which the QoE measurements are being configured. Supported services are streaming and MTSI.

The contribution CR 4297 (R2-2004624) for 3GPP TS 36.331 v16.0.0 at the 3GPP TSG RAN2 Meeting #110 proposed to extend the QoE measurement configuration.

The measConfigAppLayerToAddModList-r16 may be used to add or modify multiple QoE measurement configurations (up to maxQoE-Measurement-r16). The measConfigAppLayerToReleaseList-r16 IE may be used to remove multiple QoE measurement configuration (up to maxQoE-Measurement-r16).

### E-UTRAN-QoE Measurement Reporting-RRC Signaling

As specified in 3GPP TS 36.331, the MeasReportAppLayer RRC message is used by the UE to send to the E-UTRAN node the QoE measurement results of an Application (or service). The service for which the report is being sent is indicated in the “serviceType” IE.

The contribution CR 4297 (R2-2004624) for 3GPP TS 36.331 v16.0.0 at the 3GPP TSG RAN2 Meeting #110 proposed to extend the MeasReportAppLayer IEs introducing a QoE reference comprising the PLMN identity and the identifier of the QoE Measurement Collection.

For E-UTRAN, an example of desired UE behavior for Application layer measurement reporting is described in CR 4297 (R2-2004624):

### UE Application Layer Measurement Configuration

The “UE Application layer measurement configuration” IE is described in 3GPP TS 36.413 v16.3.0 and TS 36.423 v16.3.0.

### Full Configuration

As part of handover preparation to a target node, the source node sends the current UE configuration to the target node in the HANDOVER REQUEST message, see TS 38.423. The target node prepares a target configuration for the UE based on the current configuration and the target node's and the UE's capabilities. The target configuration is sent from the target node in HANDOVER REQUEST ACKNOWLEDGE to the source node and onwards to the UE in RRCReconfiguration. As a streamlined option, the target configuration can be provided as a so called delta-configuration, indicating only the differences from the UE's current configuration in the source cell.

However, if the target node does not recognize something in the UE's current configuration, it is due to that the target node does not support some feature which the source node supports. In such case the target node will trigger a full configuration, meaning that the UE will clear the current radio configuration and make a new configuration over again. This is further described in TS 38.331 chapter 5.3.5.11. This will also be applicable for the case where the target nodes does not support QoE measurements, or does not support QoE measurements of a certain type which the source node supports and which the UE is configured with.

### AT Commands

AT commands are used for communication between the AS (radio) layer and the application layer in the UE. The AT commands are defined in 3GPP TS 27.007.

There currently exist certain challenge(s). For example, A problem with existing full configuration (fullConfig) is that the UE behavior for QoE measurements is unclear. In the existing specification the radio configuration is cleared, but higher layer configurations are not cleared. The QoE configuration is a higher layer configuration, but it also has some configuration in RRC, i.e. a radio configuration. Therefore, it is not clear how the QoE configurations will be handled if a handover with fullConfig is triggered.

### SUMMARY

An object of embodiments herein is to improve the handling of QoE configurations when a handover with full configuration is triggered.

According to an aspect, the object is achieved by a method performed by a user equipment for handling Quality of Experience (QoE) configurations. The method comprises:

The user equipment receives, from a network node, a message including a request for full configuration.

The user equipment sends one or more Attention (AT) commands from the Radio Resource Control, RRC, layer of the user equipment to the application layer of the user equipment. The AT command includes at least one of: an indication to release all QoE configurations in the initial set following a mobility event, an indication to not release any of the initial set of QoE configurations following a mobility event, or an indication to set the initial set of QoE configurations on hold, a list of QoE configuration identifiers corresponding to one or more QoE configurations to be released by the user equipment (120) following a mobility event, and a list of QoE configuration identifiers corresponding to one or more QoE configurations to be retained by the user equipment following a mobility event if the received message includes the list of QoE configuration identifiers.

The user equipment performs one of the following based on the one or more AT commands:
setting the initial set of QoE configurations on hold in the application layer,
retaining the initial set of QoE configurations in the application layer; and
releasing one or more QoE configurations in the initial set of QoE configurations.

According to another aspect, the object is achieved by a method performed by a source network node. The method is for handling Quality of Experience (QoE) configurations. The method comprises:

The source network node sends a message to a user equipment. The message includes a request for full configuration. The message further comprises at least one of: a list of QoE configuration identifiers corresponding to one or more QoE configurations to be retained by the user equipment following a mobility event, a list of QoE configuration identifiers corresponding to one or more QoE configurations to be released by the user equipment following a mobility event, a parameter indicating that no QoE configurations are to be released following a mobility event, and an indication that a target node of a handover does not support the one or more QoE configurations that are supported by the network node.

According to another aspect, the object is achieved by a method performed by a target network node. The method is for handling Quality of Experience (QoE) configurations.

The target network node receives a handover request from a source network node. The handover request comprises a current configuration of a user equipment.

The target network node sends a handover command to the source network node. The handover command is sent upon acceptance of the handover request. The handover command comprises a message including a request for full configuration.

The message further comprises at least one of: a list of QoE configuration identifiers corresponding to one or more QoE configurations to be retained by the user equipment following a mobility event, a list of QoE configuration identifiers corresponding to one or more QoE configurations to be released by the user equipment following a mobility event a parameter indicating that no QoE configurations are to be released following a mobility event, and an indication that the target node does not support the one or more QoE configurations that are supported by the source network node.

According to another aspect, the object is achieved by a user equipment for handling Quality of Experience (QoE) configurations. The user equipment comprises:
a processing circuitry configured to cause the user equipment to perform any of the steps:
   receiving, from a network node, a message including a request for full configuration,
   sending one or more Attention (AT) commands from the Radio Resource Control (RRC) layer of the user equipment to the application layer of the user equipment, wherein the AT command includes at least one of: an indication to release all QoE configurations in the initial set following a mobility event, an indication to not release any of the initial set of QoE configurations following a mobility event, or an indication to set the initial set of QoE configurations on hold, a list of QoE configuration identifiers corresponding to one or more QoE configurations to be released by the user equipment following a mobility event, and a list of QoE configuration identifiers corresponding to one or more QoE configurations to be retained by the user equipment following a mobility event if the received message includes the list of QoE configuration identifiers; and
performing one of the following based on the one or more AT commands:
   setting the initial set of QoE configurations on hold in the application layer;
   retaining the initial set of QoE configurations in the application layer; and
   releasing one or more QoE configurations in the initial set of QoE configurations; and
which user equipment further comprises power supply circuitry configured to supply power to the processing circuitry.

According to another aspect, the object is achieved by a source network node for handling Quality of Experience (QoE) configurations. The source network node comprises:
processing circuitry configured to cause the network node to perform the step of:
sending, to a user equipment, a message including a request for full configuration, wherein the message further comprises at least one of: a list of QoE configuration identifiers corresponding to one or more QoE configurations to be retained by the user equipment following a mobility event, a list of QoE configuration identifiers corresponding to one or more QoE configurations to be released by the user equipment following a mobility event, a parameter indicating that no QoE configurations are to be released following a mobility event, and an indication that a target node of a handover does not support the one or more QoE configurations that are supported by the network node.

The source network node further comprises power supply circuitry configured to supply power to the processing circuitry.

According to another aspect, the object is achieved by a target network node for handling Quality of Experience (QoE) configurations. The target network node comprises:
processing circuitry configured to cause the network node to perform any of the steps of any of:
   receiving, from a source network node, a handover request comprising a current configuration of a user equipment; and
   sending, to the source network node, a handover command upon acceptance of the handover request, wherein the handover command comprises a message including a request for full configuration.

The message further comprises at least one of: a list of QoE configuration identifiers corresponding to one or more QoE configurations to be retained by the user equipment following a mobility event, a list of QoE configuration identifiers corresponding to one or more QoE configurations to be released by the user equipment following a mobility event a parameter indicating that no QoE configurations are to be released following a mobility event, and an indication that the target node does not support the one or more QoE configurations that are supported by the source network node.

The target network node further comprises a power supply circuitry configured to supply power to the processing circuitry.

Certain embodiments may provide one or more of the following technical advantage(s). For example, certain embodiments can enable the fulfillment of one of the basic 3GPP requirements (specified by 3GPP SA4)—that an ongoing QoE measurement session shall proceed until the end of the application session, unless the QoE configuration is released by the network.

Another advantage provided by certain embodiments is that the network does not have to resend QoE configurations at handover with fullConfig, i.e. the QoE configurations that have previously been configured in the UE. That means that the size of the Handover Command can be significantly reduced. The Handover Command is often sent in poor and deteriorating radio conditions and it is important that the size of the Handover Command is limited to increase the likelihood of successful transmission of the handover command and hence a successful handover.

According to certain embodiments, the UE doesn't have to store anything related to QoE measurements and their associated configuration in the UE AS layer at handover with fullConfig, but the QoE measurements can still continue after the handover without having to transmitting the large QoE configuration files in the Handover Command.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a sequence diagram depicting Prior art.

FIG. 2 is a sequence diagram depicting Prior art.

FIG. 3 is a sequence diagram depicting Prior art.

FIG. 4 is a schematic block diagram depicting embodiments of a communications network.

FIG. 5 is a sequence diagram depicting embodiments of a method.

FIG. 6 illustrates a method in accordance with some embodiments.

FIG. 7 illustrates a method in accordance with some embodiments.

FIG. 8 illustrates a method in accordance with some embodiments.

FIG. 9 is a schematic block diagram depicting embodiments of a user equipment.

FIG. 10 is a schematic block diagram depicting embodiments of a source network node.

FIG. 11 is a schematic block diagram depicting embodiments of a target network node.

FIG. 12 shows an example of a communication system QQ100 in accordance with some embodiments.

FIG. 13 shows a UE in accordance with some embodiments;

FIG. 14 shows a network node in accordance with some embodiments;

FIG. 15 is a block diagram of a host, which may be an embodiment of the host of FIG. 12, in accordance with various aspects described herein;

FIG. 16 is a block diagram illustrating a virtualization environment in which functions implemented by some embodiments may be virtualized; and

FIG. 17 shows a communication diagram of a host communicating via a network node with a UE over a partially wireless connection in accordance with some embodiments.

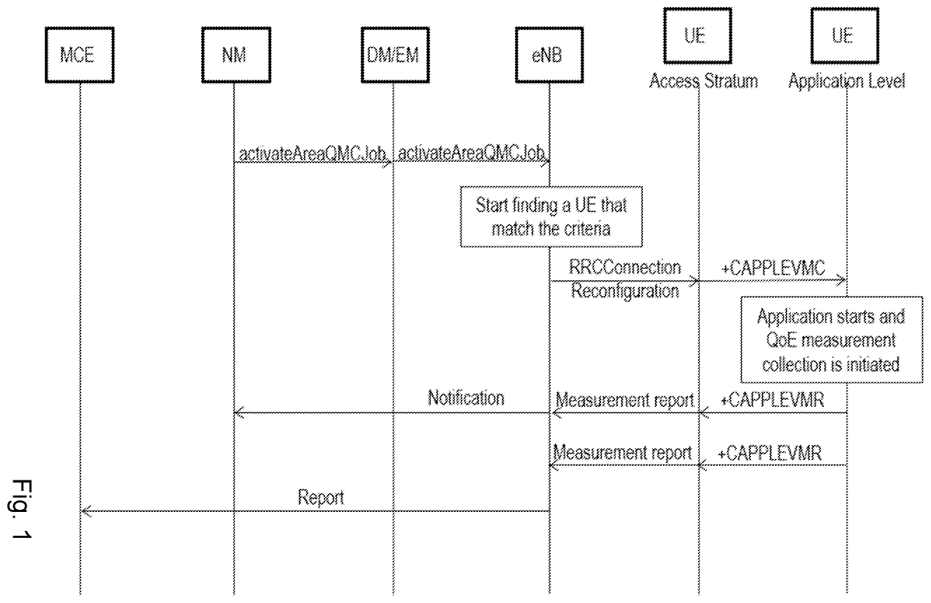

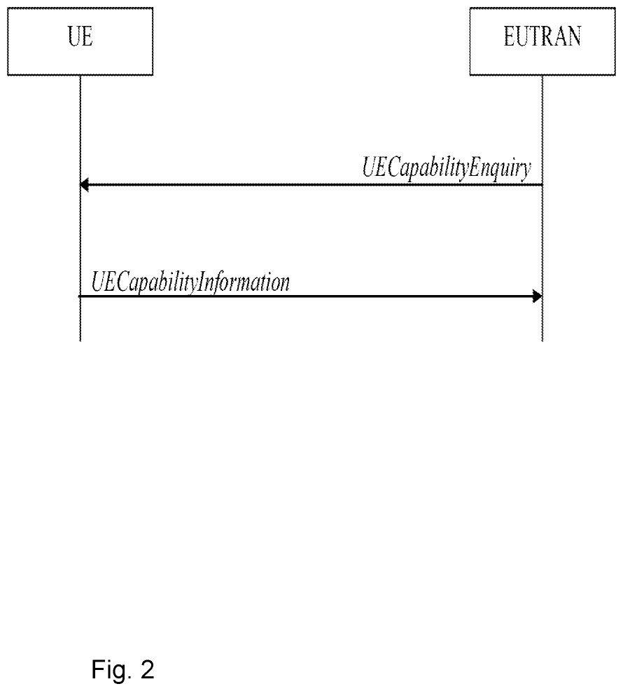

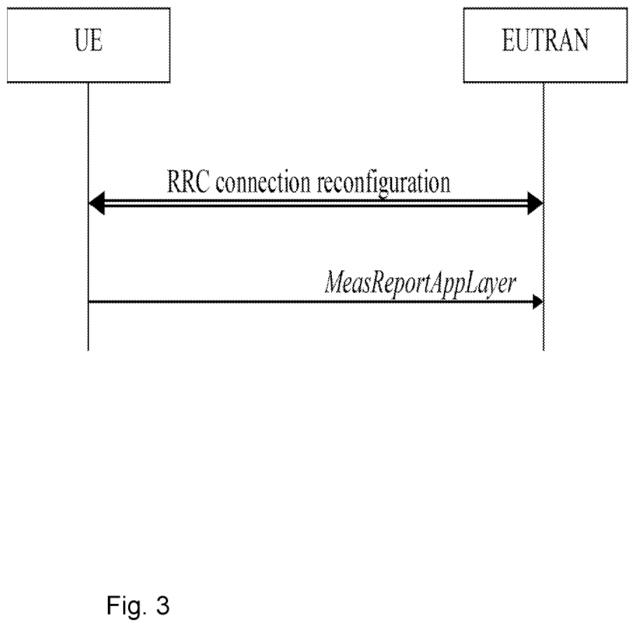

### DESCRIPTION

Certain aspects of the disclosure and their embodiments may provide solutions to these or other challenges.

A solution is described herein where the application layer is responsible for keeping the QoE configurations during handover with fullConfig and where the application layer may ensure that the measurements configurations indicated by the network continues after the handover and where other measurements configurations are released. At the handover with fullConfig, the network may indicate which QoE measurements should continue after the handover, the Access Stratum (AS) layer in the UE may forward the indicated QoE measurements configurations to the application layer so that the application layer knows which measurements configurations to keep and which measurements to release.

In an alternative solution described herein, the network may indicate which QoE measurements to be released at the handover. Thereby, the UE does not have to store anything the UE AS layer either during fullConfig. In this solution, the network has to indicate to the UE that no QoE measurements are released if that is the case, in order to separate from the case where the target does not support QoE measurements. In such case the target cannot indicate anything, and indicating nothing means that the UE should release all QoE measurements.

Solutions to allow QoE measurements to continue in the UE at handover with fullConfig without having to resend all QoE configuration files to the UE are described herein.

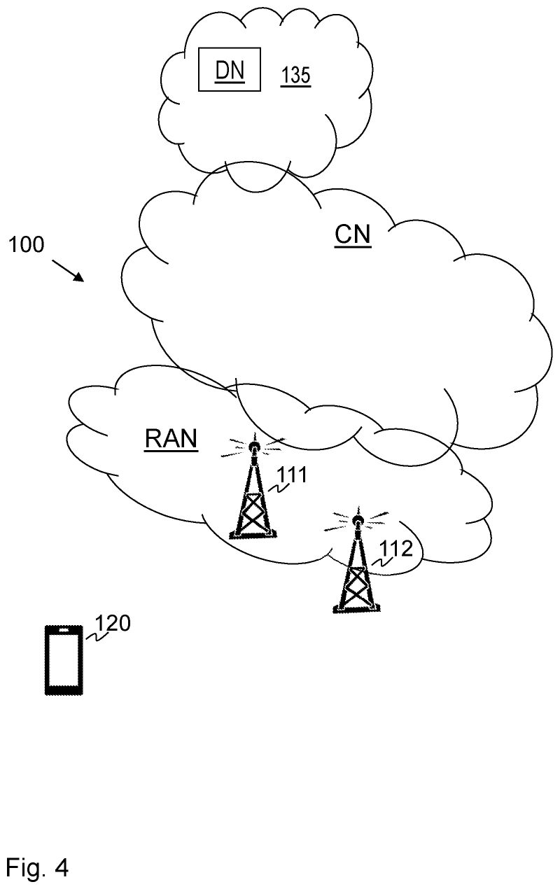

FIG. 4 is a schematic overview depicting a communications network 100, such as e.g. the communications network QQ100 described below, wherein embodiments herein may be implemented. The communications network 100 comprises one or more RANs and one or more CNs. The communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a source network node 111 and a target network node 112, operate in the communications network 100. The respective source network node 111 and target network node 112 e.g. provides a number of cells and may use these cells for communicating with UEs such as e.g. a UE 120. The respective source network node 111 and target network node 112 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the respective source network node 111 and target network node 112 depending e.g. on the radio access technology and terminology used. UEs, such as e.g. a UE 120, operate in the communications network 100. The UE 120 may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the UE 120 and the respective source network node 111 and target network node 112, in another aspect by the UE 120. As an alternative, a Distributed Node (DN) and functionality, e.g. comprised in a cloud 135 as shown in FIG. 4, may be used for performing or partly performing the methods of embodiments herein.

### Additional Explanation.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

FIG. 5 Illustrates Handling of QoE Configurations at Handover with fullConfig

In the embodiment as shown in FIG. 5, the UE 120 is connected in a cell served by a source gNB 111, also referred to as source network mode 111 and source node 111, and is configured with QoE measurements. When the QoE measurements were configured the network sent the QoE configuration files and the identities of the measurements, e.g. the measConfigAppLayerId to the UE. The measConfigAppLayerId is an identity used in RRC signaling, but other identities may also be used such as the QoE Reference or service type. In this embodiment it is assumed that the measConfigAppLayerId is forwarded to the application layer in the UE when the QoE measurements are configured.

The UE sends 501 a Measurement Report to the source node 111. The source node 111 (“Source gNB 111”) may decide 502 that a handover is needed and may send 503 a request for handover to a target node, such as the target network mode 112. The current UE configuration may be included in the handover request. The target network node, also referred to as target node 112 and gNB 112, may accept or reject the request, and in the case where the target node accepts the request, it may decide and prepare 504 on a UE target configuration and whether to use delta configuration or full configuration in the Handover Command. The present embodiment is related to the case where fullConfig is used.

The target node 112 may observe that the UE is configured with QoE measurements and decide on which configuration(s) should continue in the target cell/node. The target node 112 may then indicate the identities of these QoE configurations in the Handover Command e.g. in a HANDOVER REQUEST ACKNOWLEDGE sent 505 to the source node 111. The target node may, for example, use the measConfigAppLayerId to indicate the identity of a QoE configuration, but other identities may also be used, such as a QoE Reference, the service type of the measurement, etc.

The source node 111 may forward 506 the Handover Command to the UE 120 in the form of an RRCReconfiguration message, and the UE 120 may get the indication of handover with fullConfig. The UE 120 may then clear the radio configurations at fullConfig, but the QoE configurations in the application layer are not cleared. The identities of the QoE measurements, e.g. the measConfigAppLayerId are not cleared either, but are kept in the application layer at the handover. 507.

A new AT command may be used in the present embodiment, which may indicate the identities of the QoE configurations, e.g. the measConfigAppLayerId, that should continue, i.e. be kept when the UE 120 accesses the target cell. E.g. the UE 120 may forward 507 identities of QoE measurements that should continue in target node 112 to application layer. One or more AT commands may be forwarded within the UE 120 from the AS layer to the application layer, e.g. in the form of a list of measConfigAppLayerId parameters). Based on this, QoE configurations that are associated with other identities which are not indicated may be released 508. In this approach, an implicit release of the QoE configurations whose identities are not forwarded may take place. With this approach, if all QoE configurations are to be released, the UE AS may leave the list of measConfigAppLayerId parameters empty, or absent, in the one or more AT commands.

509. The UE may then send an RRCReconfigurationComplete message to the Target node 112. In some embodiments, the UE 120 may determine based on information in the handover command (i.e. in the RRCReconfiguration including the handover instructions (including the fullConfig indication) that the target cell/node lacks support for the QoE framework. In these embodiments, the QoE configurations may still be retained for a certain time (i.e. set to on-hold, for example with QoE reporting paused or both QoE measurements and QoE reporting paused), so that the QoE configurations are not discarded and may be resumed after a subsequent mobility event towards a further target cell/node supporting the QoE framework, in particular the original QoE measurements. One way that the UE may potentially determine, based on information in the handover command, that the target cell/node lacks support for the QoE framework may be based on absence of a parameter indicating treatment of QoE configurations. For instance, even if no QoE configuration is to be retained in the target cell, there may still be an empty list of QoE configurations to be retained, provided that the target node supports the QoE framework. Hence, absence of this list (i.e. not even presence of an empty list) would implicitly indicate that the target cell/node lacks support for the QoE framework. Another way may be if an explicit indication of support for the QoE framework is introduced. Then, the absence of this indication may be interpreted as an indication of lack of support for the QoE framework.

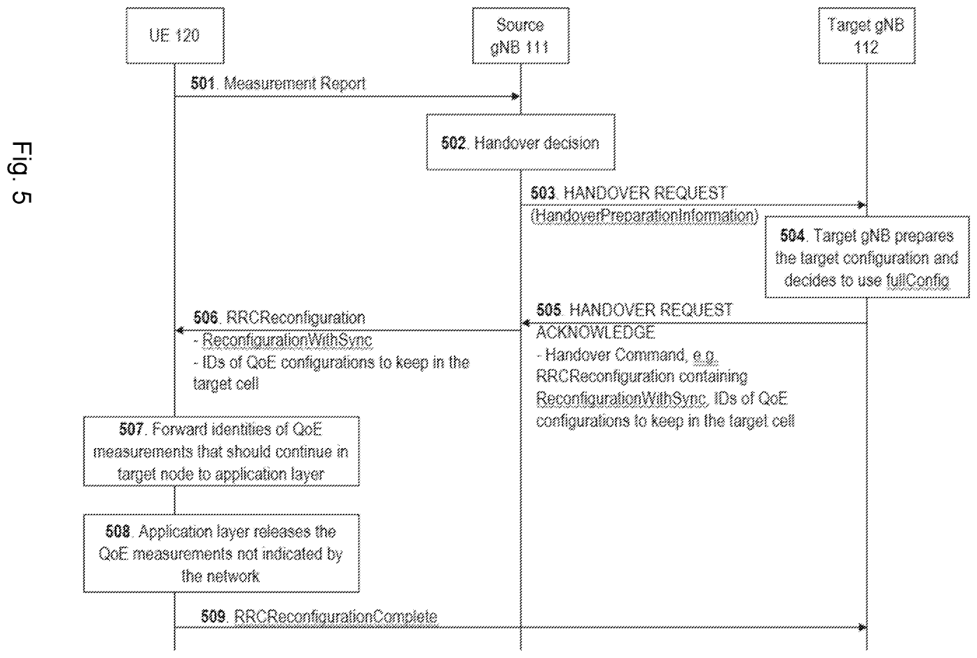

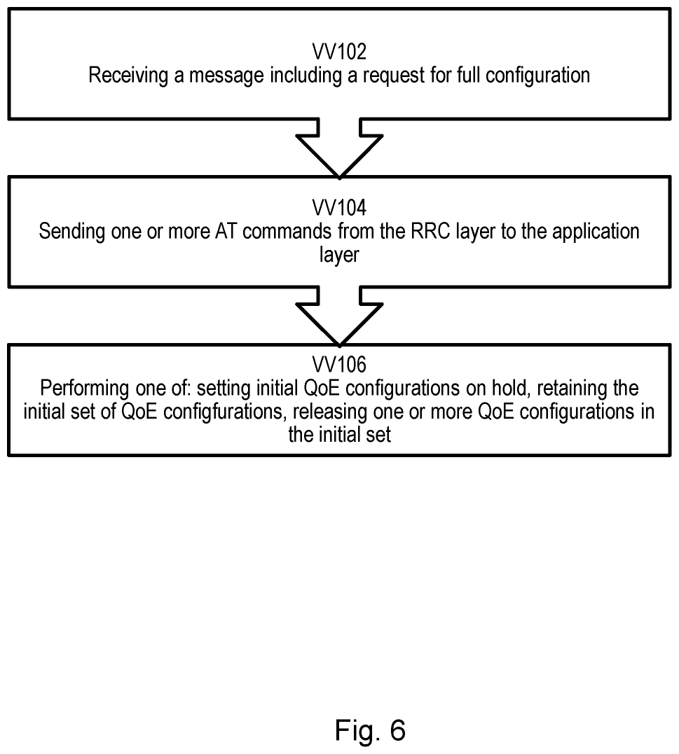

FIG. 6 depicts a method VV1 in accordance with particular embodiments related to Group A Embodiments. The method VV1 may be performed by a UE 120 or wireless device (e.g. the UE QQ112 or UE QQ200 as described later with reference to Figures QQ1 and QQ2 respectively). The method begins at step VV102 with receiving, from a network node, a message including a request for full configuration.

Then, the method proceeds to step VV104 with sending one or more Attention (AT) commands from the Radio Resource Control (RRC) layer of the user equipment to the application layer of the user equipment. The AT command includes at least one of: an indication to release all QoE configurations in the initial set following a mobility event, an indication to not release any of the initial set of QoE configurations following a mobility event, an indication to set the initial set of QoE configurations on hold, a list of QoE configuration identifiers corresponding to one or more QoE configurations to be released by the user equipment 120 following a mobility event, and a list of QoE configuration identifiers corresponding to one or more QoE configurations to be retained by the user equipment 120 following a mobility event if the received message includes the list of QoE configuration identifiers.

Then, the method proceeds to step VV106 with performing one of the following based on the one or more AT commands: setting the initial set of QoE configurations on hold in the application layer, retaining the initial set of QoE configurations in the application layer, and releasing one or more QoE configurations in the initial set of QoE configurations.

In some embodiments, releasing one or more QoE configurations in the initial set of QoE configurations at step VV106 may be performed in the application layer.

In some embodiments where the one or more AT command includes a list of QoE configuration identifiers corresponding to one or more QoE configurations to be retained, releasing one or more QoE configurations in the initial set at step VV106 may comprise releasing one or more QoE configurations that does not correspond to the any one in the list of QoE configuration identifiers.

In some embodiments, the list of QoE configuration identifiers corresponding to QoE configuration(s) to be retained may be empty. In these embodiments, the one or more AT command may further include an indication to not release any of the initial set of QoE configurations.

In some embodiments, the message may not include a list of one or more QoE configurations to be retained by the user equipment 120, and in these embodiments the message may further comprise a parameter indicating that no QoE configurations are to be released. Furthermore, the one or more AT commands may include an indication to not release any of the initial set of QoE configurations.

In some embodiments, the mobility event may be a handover, or a resume event, or a reestablishment event, and the network node may be a source network node 111. In these embodiments, the parameter indicating that no QoE configurations are to be released may further indicate that a target node supports the one or more QoE configurations that are supported by the source network node 111. The parameter may comprise at least one of: a flag, a Boolean, and an ENUMERATED parameter.

In some embodiments, the message may not include a list of one or more QoE configurations to be retained by the user equipment 120. In these embodiments, the one or more AT commands may include an indication to release all QoE configurations in the initial set or an indication to set the initial set of QoE configurations on hold.

In some embodiments, the mobility event may be a handover, or a resume event, or a reestablishment event, and the network node may be a source network node 111. In these embodiments, the message may further include an indication that a target node does not support the one or more QoE configurations that are supported by the source network node 111.

In some embodiments where the message includes a list of QoE configuration identifiers corresponding to one or more QoE configurations to be retained, the method further may further comprises, subsequent to one or more QoE configuration identifiers being deleted in the RRC layer as a result of the request for full configuration, restoring one or more QoE configuration identifiers at the RRC layer that correspond to the list of QoE configuration identifiers corresponding to one or more QoE configurations to be retained. Furthermore, the method may comprise, subsequent to one or more QoE configurations being released in the RRC layer as a result of the request for full configuration, restoring one or more parameters associated with the one or more QoE configurations that correspond to the list of QoE configuration identifiers corresponding to one or more QoE configurations to be retained.

In some embodiments where the method comprises releasing one or more QoE configurations in the initial set of QoE configurations in the application layer, the method may further comprise retaining, in the RRC layer, one or more QoE configurations at the RRC layer that corresponds to the initial set of QoE configurations subsequent to receiving the message including the request for full configuration, and releasing one or more QoE configurations retained in the RRC layer that correspond to the one or more QoE configurations released in the application layer.

In some embodiments, a QoE configuration identifier may be one of: a measConfigAppLayerId, a QoE reference, or a service type of the QoE measurement.

In some embodiments, the message may be a RRCReconfiguration message.

In some embodiments, the mobility event may be one of: a handover from the network node to a target network node 112, a RRC Resume event, a Reconfiguration with sync event, and a RRC Reestablishment event.

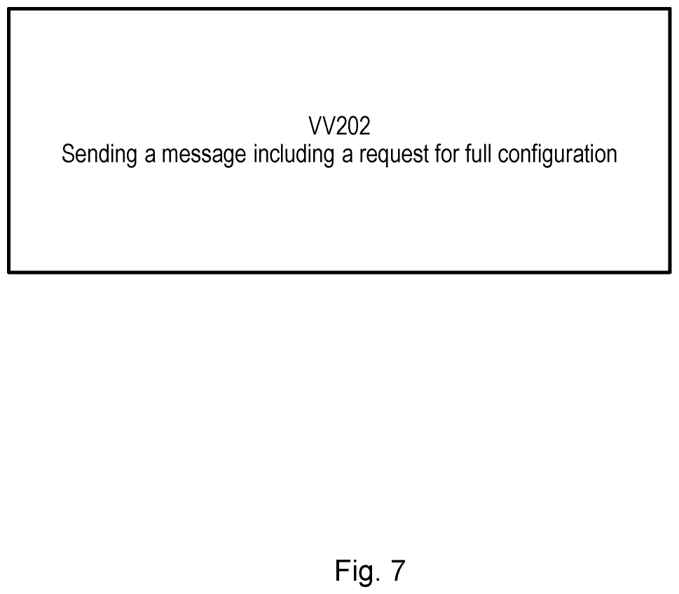

FIG. 7 depicts a method VV2 in accordance with particular embodiments related to Group B Embodiments. The method VV2 may be performed by a network node such as e.g., the source network node 111, (e.g. the network node QQ110 or network node QQ300 as described later with reference to Figures QQ1 and QQ3 respectively). The method begins at step VV202 with sending a message to a user equipment 120, the message including a request for full configuration. The message further comprises at least one of: a list of QoE configuration identifiers corresponding to one or more QoE configurations to be retained by the user equipment 120 following a mobility event, a list of QoE configuration identifiers corresponding to one or more QoE configurations to be released by the user equipment 120 following a mobility event, a parameter indicating that no QoE configurations are to be released following a mobility event, and an indication that a target node of a handover does not support the one or more QoE configurations that are supported by the network node. In some embodiments, the method may further comprise, prior to sending the request for full configuration and the list of QoE configuration identifiers, sending a handover request to a target node, wherein the handover request comprises a current set of one or more QoE configurations of the user equipment 120, and receiving, from the target node, a handover command upon acceptance of the handover request at the target node, wherein the handover command comprises the request for full configuration prepared in response to the handover request. In these embodiments, sending the message to the user equipment 120 at step VV202 may comprise forwarding the handover command to the user equipment 120.

In some embodiments, the handover command may further comprise at least one of the list of QoE configuration identifiers corresponding to one or more QoE configurations to be retained by the user equipment 120 or the list of QoE configuration identifiers corresponding to one or more QoE configurations to be released by the user equipment 120. In these embodiments, at least one of the lists of QoE configuration identifiers may be prepared based on at least one of: the current set of QoE configurations of the user equipment 120, a capability of the target node, and a capability of the user equipment 120.

In some embodiments, the message may comprise the list of QoE configuration identifiers corresponding to one or more QoE configurations to be retained by the user equipment 120, and in these embodiments the list may be empty.

In some embodiments, the parameter indicating that no QoE configurations are to be released further may indicate that a target node supports the one or more QoE configurations that are supported by the network node. The parameter may comprise at least one of: a flag, a Boolean, and an ENUMERATED parameter.

In some embodiments, a QoE configuration identifier may be one of: a measConfigAppLayerId, a QoE reference, or a service type of the QoE measurement.

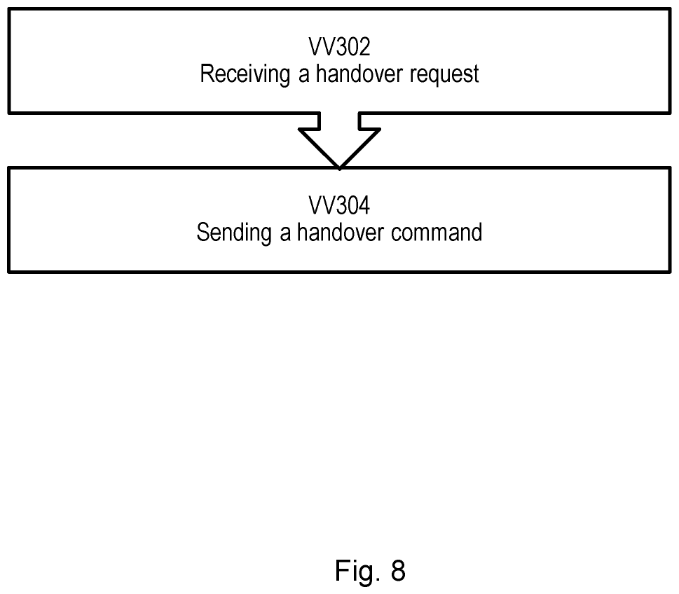

FIG. 8 depicts a method VV3 in accordance with particular embodiments also related to the Group B Embodiments. The method VV3 may be performed by a network node such as e.g., the target network node 112, (e.g. the network node QQ110 or network node QQ300 as described later with reference to Figures QQ1 and QQ3 respectively). The method begins at step VV302 with receiving, from a source network node 111, a handover request comprising a current configuration of a user equipment 120.

Then, the method proceeds to VV304 with sending, to the source network node 111, a handover command upon acceptance of the handover request. The handover command comprises a message including a request for full configuration. The message further comprises at least one of: a list of QoE configuration identifiers corresponding to one or more QoE configurations to be retained by the user equipment 120 following a mobility event, a list of QoE configuration identifiers corresponding to one or more QoE configurations to be released by the user equipment 120 following a mobility event a parameter indicating that no QoE configurations are to be released following a mobility event, and an indication that the target node does not support the one or more QoE configurations that are supported by the source network node 111.

In some embodiments, the method may further further comprise, prior to sending the handover command, generating the list of QoE configuration identifiers corresponding to one or more QoE configurations to be retained by the user equipment 120 or the list of QoE configuration identifiers corresponding to one or more QoE configurations to be released by the user equipment 120 based on at least one of: the current set of QoE configurations of the user equipment 120, a capability of the target node, and a capability of the user equipment 120, wherein the message comprises the list of QoE configuration identifiers.

In some embodiments, the list of QoE configuration identifiers corresponding to one or more QoE configurations to be retained by the user equipment 120 may be empty.

In some embodiments, a QoE configuration identifier may be one of: a measConfigAppLayerId, a QoE reference, or a service type of the QoE measurement.

In some embodiments, the parameter indicating that no QoE configurations are to be released may further indicate that the target node supports the one or more QoE configurations that are supported by the network node. The parameter may comprise at least one of: a flag, a Boolean, and an ENUMERATED parameter.

### Terminology and Generalizations

It should be noted that the term “can” also may include the term “may” and the term “may” also may include the term “can”, and these terms may be used interchangeably herein. The terms “UE”, “terminal equipment” and “wireless terminal” are used interchangeably.

The terms MCE and TCE are used interchangeably.

The terms “network node” and “RAN node” are used interchangeably, where the RAN node may be a gNB, eNB, gNB-CU, gNB-CU-CP, eNB-CU, eNB-CU-CP, IAB-donor, IAB-donor-CU, IAB-donor-CU-CP.

The terms “application layer measurement configuration”, “application measurement configuration”, “QoE measurement configuration” and “QoE measurement and reporting configuration” are used interchangeably.

The terms “modem”, “radio layer”, “RRC layer” and “radio network layer” are used interchangeably.

The terms access stratum and radio layer are used interchangeably.

The solution proposed in this invention applies to UMTS, LTE and NR.

All references to the application layer are with respect to the application layer of the UE (since RAN nodes do not have an application layer).

The solution proposed in this invention applies to both signaling- and management-based MDT and QoE measurements.

Even though primarily described when applied in conjunction with handover, the present invention pertains to all the procedures where fullConfig is received, e.g. at least RRC Resume, Reconfiguration with sync or RRC Reestablishment.

The solution is primarily described in 5G/NR terms, implying application of the solution in 5G/NR, but the solution is also applicable in LTE (in which case for instance a gNB would be replaced by an eNB, and an RRCReconfiguration message would be replaced by an RRCConnectionReconfiguration message).

Application Layer Handling of QoE Measurements at Handover with fullConfig

An example implementation of an AT command in TS 27.007 (v17.2.0) is shown below, where <app-meas_config-continuation> pertains to the embodiments described herein:

### Application Level Measurement Configuration +CAPPLEVMC

TABLE 8.78-1
+CAPPLEVMC parameter command syntax

| Command | Possible response(s) |
|---|---|
| +CAPPLEVMC=[<n>] | +CME ERROR: <err> |
| +CAPPLEVMC? | +CAPPLEVMC: <n> |
| +CAPPLEVMC=? | +CAPPLEVMC: (list of supported <n>s) |

### Description

This command allows control of the application level measurement configuration according to 3GPP TS 25.331 and 3GPP TS 36.331 [86]. The set command controls the presentation of the unsolicited result code +CAPPLEVMC: <app-meas_service_type>,<start-stop_reporting> [,<app-meas_config_file_length>,<app-meas_config-file>, <app-meas_config-id>, <app-meas_config-continuation>] providing data for the configuration. Refer clause 9.2 for possible <err> values.
Read command returns the current value of <n>.
Test command returns values supported as a compound value.
Defined values
<n>: integer type. Disable and enable presentation of the unsolicited result code +CAPPLEVMC to the TE.
Disable presentation of the unsolicited result code
Enable presentation of the unsolicited result code
<app-meas_service_type>: integer type. Contains the indication of what application that is target for the application level measurement configuration.
QoE measurement collection for streaming services
QoE measurement collection for MTSI services
<start-stop_reporting>: integer type. Indicates the start and stop of the application level measurement reporting for the application indicated by the <app-meas_service_type>.
start the application level measurement reporting
stop the application level measurement reporting
<app-meas_config_file_length>: integer type. Indicates the number of octets of the <app-meas_config-file> parameter.
<app-meas_config-file>: string of octets. Contains the application level measurement configuration file for the application indicated by the <app-meas_service_type>. The parameter shall not be subject to conventional character conversion as per +CSCS.
<app-meas_config-id>: integer type. Contains the measConfigAppLayerId of the application level measurement configuration.
<app-meas_config-continuation>: integer type. Indicates the continuation of the application level measurement reporting for the application level measurement indicated by the <app-meas_config-id>. If <app-meas_config-continuation> is indicated for any <app-meas_config-id>, application layer measurements of other <app-meas_config-id> are released, even application layer measurements of <app-meas_config-id> not indicated.
release the application level measurement reporting
continue the application level measurement reporting
release all application level measurement reporting
continue all application level measurement reporting
Implementation
Optional.

When the UE application layer receives an indication that some QoE measurements should continue, the application layer may continue the QoE measurements for these measConfigAppLayerId's and release the other application layer measurements which identities were not indicated. Thereby, the QoE measurements may continue in the UE at handover with fullConfig even if the radio configurations are cleared in the UE.

Access Stratum Handling of QoE Configurations at Handover with fullConfig

In some embodiments, the UE AS, e.g. the UE RRC layer, rather than the UE application layer may ensure appropriate handling of the existing QoE configurations in conjunction with handover with fullConfig. This may be achieved without changing the way the UE clears, releases or deletes all or parts (in accordance with the specified standard) of its configuration(s) (i.e configuration(s) related to network access, bearers, etc.) upon reception of the fullConfig indication. The UE application layer thus does not have to be aware of the particular situation, e.g. it does not have to be aware of that a mobility event, e.g. a handover, occurs, and thus the UE application layer keeps its QoE configuration(s).

To this end, the target gNB may indicate in the HandoverCommand (which may be sent from the target gNB to the source gNB in the HANDOVER REQUEST ACKNOWLEDGE message and forwarded by the source gNB to the UE in the form of an RRCReconfiguration message) which QoE configurations the UE should release (i.e. delete) when accessing the target cell. This may be indicated by means of the measConfigAppLayerId identifiers of the QoE configurations that should be released (i.e. deleted), e.g. a list of measConfigAppLayerId parameters.

Upon reception of this/these indication(s), the UE AS, e.g. the UE RRC layer, may send one or more AT commands to the UE application layer, instructing it to release (i.e. delete) the QoE configurations that the target gNB has indicated should be released (i.e. deleted). In some embodiments, if no QoE configuration is to be released, the target gNB may indicate this in the HandoverCommand by including an empty list of measConfigAppLayerId parameters. Alternatively, in some embodiments, the target gNB may indicate that no QoE configuration should be released by omitting the indication of QoE configuration(s) to be released, e.g. omitting the list of measConfigAppLayerId parameters, and setting a parameter, e.g. a flag, a Boolean or an ENUMERATED parameter, to indicate that the target cell/gNB supports the QoE framework. Alternative or additional options may include any explicit indication of that no QoE configuration(s) should be released.

The above ways to indicate that no QoE configuration should be released serves to ensure proper UE behavior in the case where the target cell/gNB does not support the QoE framework, and consequently does not indicate anything related to QoE in the HandoverCommand. Hence, when the received RRCReconfiguration message including reconfiguration WithSync and fullConfig parameters/indications, the UE AS, e.g. the UE RRC layer, may assume that the target cell/gNB does not support the QoE framework and consequently the UE AS, e.g. the UE RRC layer, may send one or more AT commands to the UE application layer, instructing the UE application layer to release (i.e. delete) all QoE configuration(s).

In some embodiments, a target gNB may explicitly indicate a lack of support of the QoE framework in the target cell/gNB, and this may trigger the UE AS, e.g. the UE RRC layer, to send one or more AT commands to the UE application layer, instructing the UE application layer to release (i.e. delete) all QoE configuration(s).

In some embodiments, when a target gNB indicates the QoE configuration(s) to be released (i.e. deleted) when the UE accesses the target cell, e.g. by including a list of measConfigAppLayerId identifiers associated with the QoE configurations to be released, the target gNB may also include (in the HandoverCommand, which is forwarded to the UE in the form of an RRCReconfiguration message) the measConfigAppLayerId identifier(s) of the QoE configurations to be kept when the UE accesses the target cell. This would serve the purpose of replacing the measConfigAppLayerId identifier(s) of this/these QoE configurations, which the UE may have deleted as a result of receiving the fullConfig indication. It is noted that this/these “replacement” measConfigAppLayerId identifier(s) has/have the same value(s) as the old one(s) which was/were deleted (or which may have been deleted).

Additionally, in some embodiments, the target gNB may not only replace the (possibly) deleted measConfigAppLayerId identifier(s) of the QoE configuration(s) to be kept when the UE accesses the target cell, but also any other (possibly) deleted parameter(s) associated with the QoE configuration(s) to be kept when the UE accesses the target cell and which parameter(s) is/are needed for the UE AS, e.g. the UE RRC layer, for performing any potential action related to the concerned QoE configuration(s).

In some embodiments, the UE RRC layer may retain all the measConfigAppLayerId parameters it has stored, even upon reception of the fullConfig indication. Then, based on the QoE configuration release instruction in the received Handover Command, the UE RRC layer may instruct the application layer to release the concerned QoE configurations, and then the UE may also release/delete the corresponding measConfigAppLayerId(s) it had stored.

In the embodiments described above, the measConfigAppLayerId may, when appropriate, be replaced by another identifier which may serve to identify one or more QoE configuration(s), e.g. a QoE reference or a Service Type indication (e.g. a serviceType or serviceType-r15 RRC parameter).

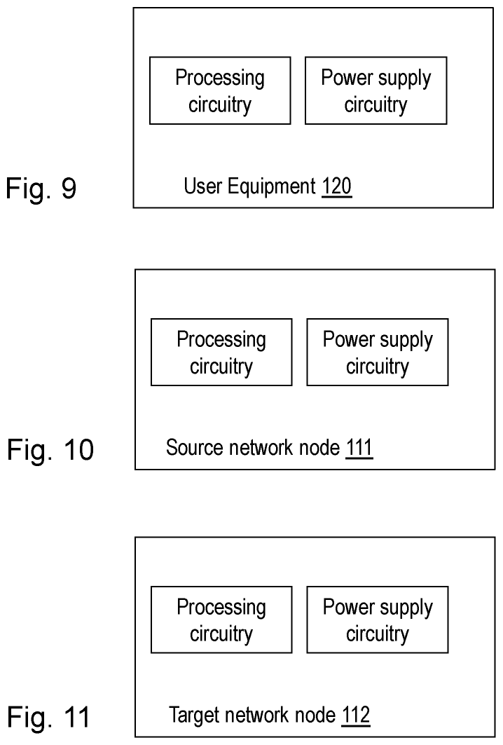

FIG. 9 depicts some embodiments of the user equipment 120, relating to some Group C Embodiments. The user equipment 120 is configured for handling Quality of Experience, QoE, configurations. The user equipment 120 comprises a processing circuitry configured to cause the user equipment 120 to perform any of the steps of any of the A Embodiments performed by the user equipment 120 as described above, comprising:

Receiving VV102, from a network node, a message including a request for full configuration,
sending VV104 one or more Attention, AT, commands from the Radio Resource Control, RRC, layer of the user equipment 120 to the application layer of the user equipment 120, wherein the AT command includes at least one of: an indication to release all QoE configurations in the initial set following a mobility event, an indication to not release any of the initial set of QoE configurations following a mobility event, or an indication to set the initial set of QoE configurations on hold, a list of QoE configuration identifiers corresponding to one or more QoE configurations to be released by the user equipment 120 following a mobility event, and a list of QoE configuration identifiers corresponding to one or more QoE configurations to be retained by the user equipment 120 following a mobility event if the received message includes the list of QoE configuration identifiers; and
performing VV106 one of the following based on the one or more AT commands:
   Setting the initial set of QoE configurations on hold in the application layer;
   retaining the initial set of QoE configurations in the application layer; and
   releasing one or more QoE configurations in the initial set of QoE configurations.

The user equipment 120 further comprises power supply circuitry configured to supply power to the processing circuitry.

The releasing of one or more QoE configurations in the initial set of QoE configurations may be performed in the application layer.

The one or more AT commands may include a list of QoE configuration identifiers corresponding to one or more QoE configurations to be retained, wherein release one or more QoE configurations in the initial set comprises releasing one or more QoE configurations that does not correspond to the anyone in the list of QoE configuration identifiers.

In some embodiments, the list of QoE configuration identifiers corresponding to one or more QoE configurations to be retained is empty. In these embodiments the one or more AT commands may include an indication to not release any of the initial set of QoE configurations.

In some embodiments, the message does not include a list of one or more QoE configurations to be retained by the user equipment 120. In these embodiments the message may further comprise a parameter indicating that no QoE configurations are to be released, and the one or more AT commands may include an indication to not release any of the initial set of QoE configurations.

In some embodiments, the mobility event may e.g. be a handover, or a resume event, or a re-establishment event. In some of these embodiments, the network node is a source network node 111. In some of these embodiments, the parameter indicating that no QoE configurations are to be released further indicates that a target node supports the one or more QoE configurations that are supported by the source network node 111.

The parameter may comprises at least one of: a flag, a Boolean, and an ENUMERATED parameter.

In some embodiments, the message does not include a list of one or more QoE configurations to be retained by the user equipment 120. In some of these embodiments, the one or more AT commands includes an indication to release all QoE configurations in the initial set or an indication to set the initial set of QoE configurations on hold.

In some embodiments, the mobility event is a handover, or a resume event, or a re-establishment event. In some of these embodiments, the network node is a source network node 111. The message may in these embodiments further include an indication that a target node does not support the one or more QoE configurations that are supported by the source network node 111.

In some embodiments, the message includes a list of QoE configuration identifiers corresponding to one or more QoE configurations to be retained. In some of these embodiments, the processing circuitry is further configured to cause the user equipment (120) to, subsequent to one or more QoE configuration identifiers being deleted in the RRC layer as a result of the request for full configuration, perform the steps of restoring one or more QoE configuration identifiers at the RRC layer that correspond to the list of QoE configuration identifiers corresponding to one or more QoE configurations to be retained.

The processing circuitry may further be configured to, cause the user equipment 120, to subsequent to one or more QoE configurations being released in the RRC layer as a result of the request for full configuration perform the step of:

Restoring one or more parameters associated with the one or more QoE configurations that correspond to the list of QoE configuration identifiers corresponding to one or more QoE configurations to be retained.

The processing circuitry may further be configured to cause the user equipment 120 to perform the steps of:
Releasing one or more QoE configurations in the initial set of QoE configurations in the application layer,
retaining, in the RRC layer, one or more QoE configurations at the RRC layer that corresponds to the initial set of QoE configurations subsequent to receiving the message including the request for full configuration; and
releasing one or more QoE configurations retained in the RRC layer that correspond to the one or more QoE configurations released in the application layer.

In some embodiments, the QoE configuration identifier is one of: a measConfigAppLayerId, a QoE reference, or a service type of the QoE measurement.

The message may be a RRCReconfiguration message.

The mobility event may e.g. be one of: A handover from the network node to a target network node 112, a RRC Resume event, a Reconfiguration with sync event, and a RRC Reestablishment event.

The processing circuitry further may further be configured to cause the user equipment 120 to perform any one or more of the steps of:
providing user data; and
forwarding the user data to a host via the transmission to the network node.

FIG. 10 depicts some embodiments of the source network node 111, relating to some Group C Embodiments. The source network node 111 is configured for handling Quality of Experience, QoE, configurations. The source network node 111 comprises a processing circuitry configured to cause the user equipment 120 to perform any of the steps of any of the B Embodiments performed by the source network node 111 as described above, comprising:

Sending VV202, to a user equipment 120, a message including a request for full configuration, wherein the message further comprises at least one of: a list of QoE configuration identifiers corresponding to one or more QoE configurations to be retained by the user equipment 120 following a mobility event, a list of QoE configuration identifiers corresponding to one or more QoE configurations to be released by the user equipment 120 following a mobility event, a parameter indicating that no QoE configurations are to be released following a mobility event, and an indication that a target node of a handover does not support the one or more QoE configurations that are supported by the network node.

The source network node 111 further comprises power supply circuitry configured to supply power to the processing circuitry.

The processing circuitry may further be configured to cause the source network node 111 to, prior to sending the request for full configuration and the list of QoE configuration identifiers, perform the steps of:
Sending a handover request to a target node, wherein the handover request comprises a current set of one or more QoE configurations of the user equipment 120;
receiving, from the target node, a handover command upon acceptance of the handover request at the target node, wherein the handover command comprises the request for full configuration prepared in response to the handover request,
wherein sending the message to the user equipment 120 comprises forwarding the handover command to the user equipment 120.

The handover command may further comprise at least one of: The list of QoE configuration identifiers corresponding to one or more QoE configurations to be retained by the user equipment 120 and the list of QoE configuration identifiers corresponding to one or more QoE configurations to be released by the user equipment 120, and wherein at least one of the lists of QoE configuration identifiers is prepared based on at least one of: the current set of QoE configurations of the user equipment 120, a capability of the target node, and a capability of the user equipment 120.

The message may comprise the list of QoE configuration identifiers corresponding to one or more QoE configurations to be retained by the user equipment 120, and the list may be empty.

The parameter indicating that no QoE configurations are to be released may further indicate that a target node supports the one or more QoE configurations that are supported by the network node.

The parameter may comprise at least one of: A flag, a Boolean, and an ENUMERATED parameter.

The QoE configuration identifier may be one of: A measConfigAppLayerId, a QoE reference, or a service type of the QoE measurement.

FIG. 11 depicts some embodiments of the target network node 112, relating to some Group C Embodiments. The target network node 112 is configured for handling Quality of Experience, QoE, configurations. The target network node 112 comprises a processing circuitry configured to cause the user equipment 120 to perform any of the steps of any of the B Embodiments performed by the target network node 112 as described above, comprising:

Receiving VV302, from a source network node 111, a handover request comprising a current configuration of a user equipment 120; and
sending VV302, to the source network node 111, a handover command upon acceptance of the handover request, wherein the handover command comprises a message including a request for full configuration,
wherein the message further comprises at least one of: a list of QoE configuration identifiers corresponding to one or more QoE configurations to be retained by the user equipment 120 following a mobility event, a list of QoE configuration identifiers corresponding to one or more QoE configurations to be released by the user equipment 120 following a mobility event a parameter indicating that no QoE configurations are to be released following a mobility event, and an indication that the target node does not support the one or more QoE configurations that are supported by the source network node 111.

The target network node 112 further comprises power supply circuitry configured to supply power to the processing circuitry.

The processing circuitry may further be configured to cause the target network node 112 to, prior to sending the handover command, perform the step of:
Generating the list of QoE configuration identifiers corresponding to one or more QoE configurations to be retained by the user equipment 120 or the list of QoE configuration identifiers corresponding to one or more QoE configurations to be released by the user equipment 120 based on at least one of: the current set of QoE configurations of the user equipment 120, a capability of the target node, and a capability of the user equipment 120, wherein the message comprises the list of QoE configuration identifiers.

The list of QoE configuration identifiers corresponding to one or more QoE configurations to be retained by the user equipment 120 may be empty.

The QoE configuration identifier is one of: A measConfigAppLayerId, a QoE reference, or a service type of the QoE measurement.

The parameter indicating that no QoE configurations are to be released may further indicate that the target node supports the one or more QoE configurations that are supported by the network node.

The parameter may comprise at least one of: A flag, a Boolean, and an ENUMERATED parameter.

The processing circuitry may further be configured to cause the target network node 112 to perform any of the steps of:
Obtaining user data; and
forwarding the user data to a host or a user equipment 120.

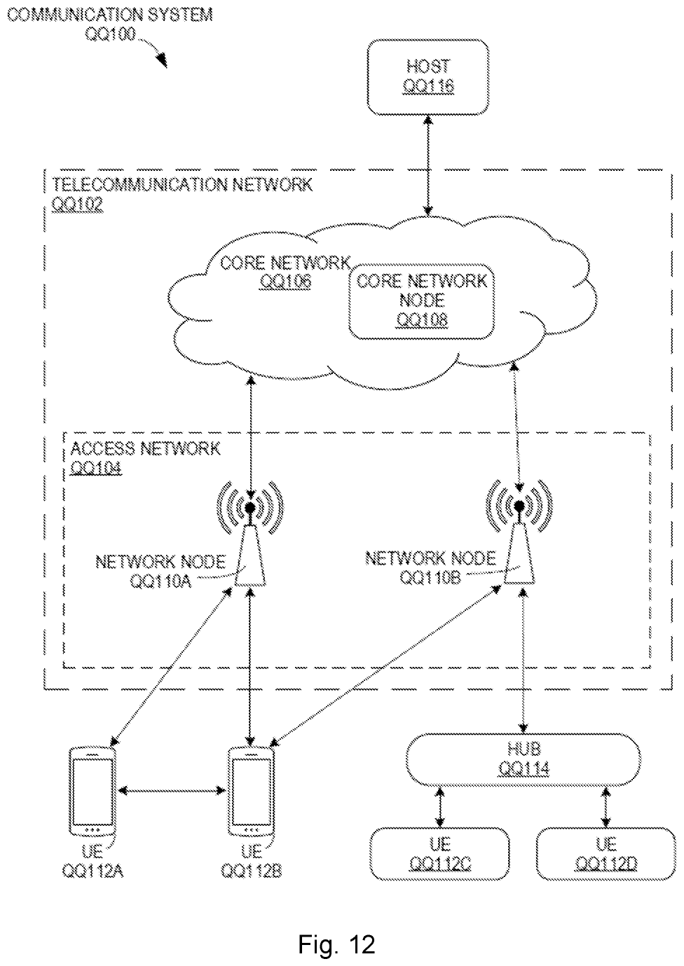

FIG. 12 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102, e.g. the communications network 100, to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 12, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

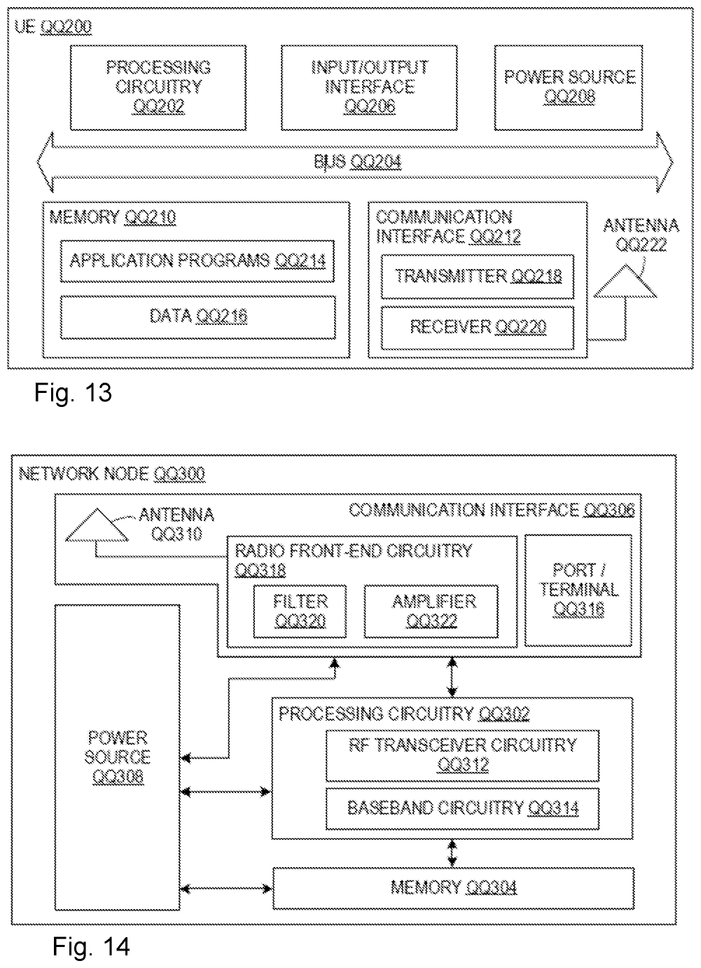

FIG. 13 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIG. 6 (VV1).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to Figure VV2 and Figure VV3.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 14 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

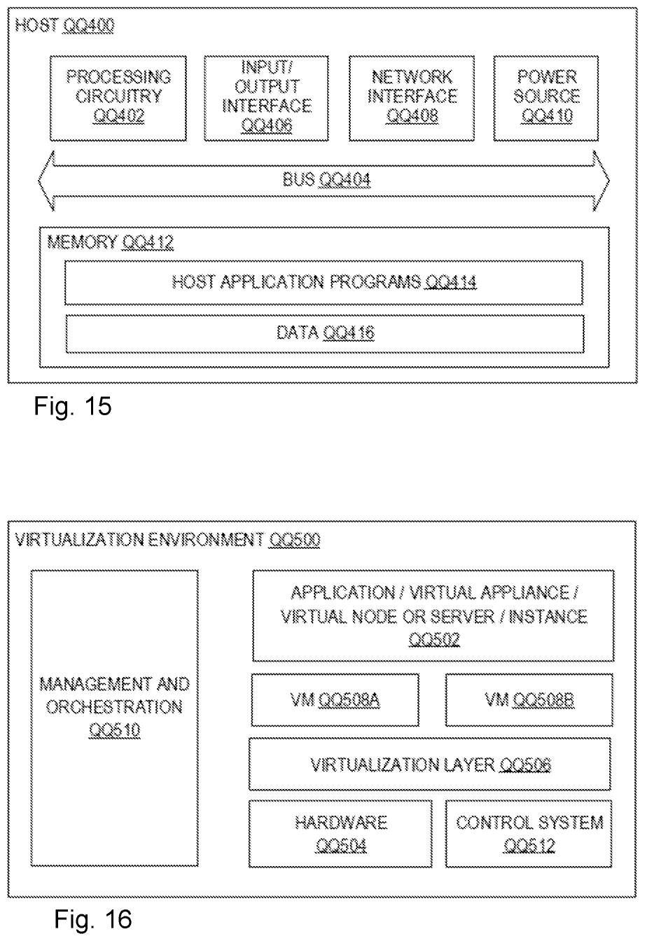

FIG. 15 is a block diagram of a host QQ400, which may be an embodiment of the host QQ116 of FIG. 12, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

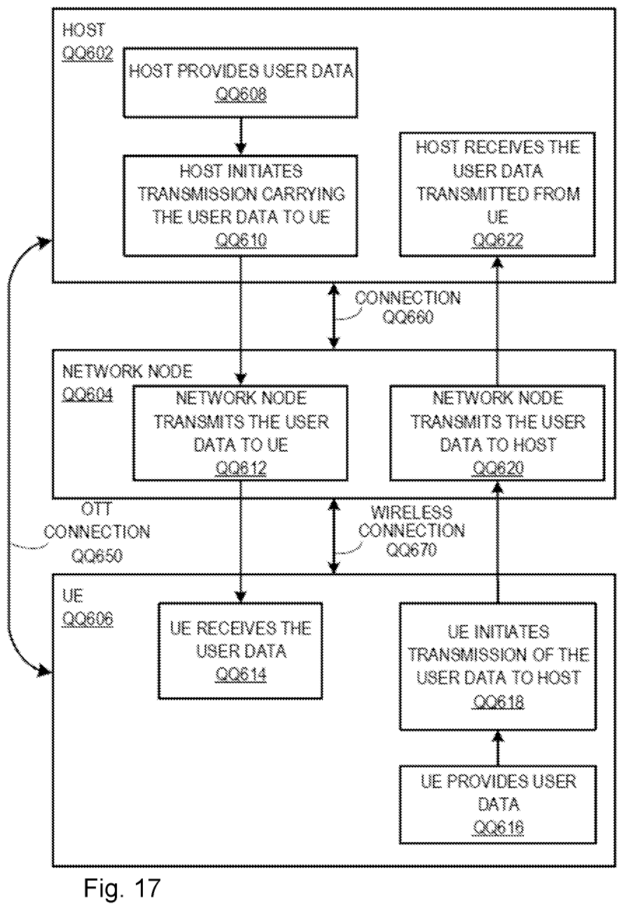

FIG. 17 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 12 and/or UE QQ200 of FIG. 13), network node (such as network node QQ110a of FIG. 12 and/or network node QQ300 of FIG. 14), and host (such as host QQ116 of FIG. 12 and/or host QQ400 of FIG. 15) discussed in the preceding paragraphs will now be described with reference to FIG. 17.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 12) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may remove or reduce the need to resend QoE configurations at handover with fullConfig, i.e. the QoE configurations that have previously been configured in the UE, thereby reducing the size of the handover command and thereby provide benefits such as increasing the likelihood of successful transmission of handover commands and hence successful handovers.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Below some further embodiments 33-57 are described.
Embodiment 33. A user equipment (120) (UE) for handling Quality of Experience (QoE) configurations, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
Embodiment 34. A host configured to operate in a communication system to provide an over-the-top (OTT) service, the host comprising:
processing circuitry configured to provide user data; and
a network interface configured to initiate transmission of the user data to a cellular network for transmission to a user equipment 120 (UE),
wherein the UE comprises a communication interface and processing circuitry, the communication interface and processing circuitry of the UE being configured to perform any of the steps of any of the Group A claims to receive the user data from the host.
Embodiment 35. The host of the previous embodiment, wherein the cellular network further includes a network node configured to communicate with the UE to transmit the user data to the UE from the host.
Embodiment 36. The host of the previous 2 embodiments, wherein:
the processing circuitry of the host is configured to execute a host application, thereby providing the user data; and
the host application is configured to interact with a client application executing on the UE, the client application being associated with the host application.
Embodiment 37. A method implemented by a host operating in a communication system that further includes a network node and a user equipment 120 (UE), the method comprising:
providing user data for the UE; and
initiating a transmission carrying the user data to the UE via a cellular network comprising the network node, wherein the UE performs any of the operations of any of the Group A claims to receive the user data from the host.
Embodiment 38. The method of the previous embodiment, further comprising:
at the host, executing a host application associated with a client application executing on the UE to receive the user data from the UE.
Embodiment 39. The method of the previous embodiment, further comprising:
at the host, transmitting input data to the client application executing on the UE, the input data being provided by executing the host application,
wherein the user data is provided by the client application in response to the input data from the host application.
Embodiment 40. A host configured to operate in a communication system to provide an over-the-top (OTT) service, the host comprising:
processing circuitry configured to provide user data; and
a network interface configured to initiate transmission of the user data to a cellular network for transmission to a user equipment 120 (UE),
wherein the UE comprises a communication interface and processing circuitry, the communication interface and processing circuitry of the UE being configured to perform any of the steps of any of the Group A claims to transmit the user data to the host.
Embodiment 41. The host of the previous claim, wherein the cellular network further includes a network node configured to communicate with the UE to transmit the user data from the UE to the host.
Embodiment 42. The host of the previous 2 embodiments, wherein:
the processing circuitry of the host is configured to execute a host application, thereby providing the user data; and
the host application is configured to interact with a client application executing on the UE, the client application being associated with the host application.
Embodiment 43. A method implemented by a host configured to operate in a communication system that further includes a network node and a user equipment 120 (UE), the method comprising:
at the host, receiving user data transmitted to the host via the network node by the UE, wherein the UE performs any of the steps of any of the Group A claims to transmit the user data to the host.
Embodiment 44. The method of the previous embodiment, further comprising:
at the host, executing a host application associated with a client application executing on the UE to receive the user data from the UE.
Embodiment 45. The method of the previous embodiment, further comprising:
at the host, transmitting input data to the client application executing on the UE, the input data being provided by executing the host application,
wherein the user data is provided by the client application in response to the input data from the host application.
Embodiment 46. A host configured to operate in a communication system to provide an over-the-top (OTT) service, the host comprising:
processing circuitry configured to provide user data; and
a network interface configured to initiate transmission of the user data to a network node in a cellular network for transmission to a user equipment 120 (UE), the network node having a communication interface and processing circuitry, the processing circuitry of the network node configured to perform any of the operations of any of the Group B claims to transmit the user data from the host to the UE.
Embodiment 47. The host of the previous embodiment, wherein:
the processing circuitry of the host is configured to execute a host application that provides the user data; and
the UE comprises processing circuitry configured to execute a client application associated with the host application to receive the transmission of user data from the host.
Embodiment 48. A method implemented in a host configured to operate in a communication system that further includes a network node and a user equipment 120 (UE), the method comprising:
providing user data for the UE; and
initiating a transmission carrying the user data to the UE via a cellular network comprising the network node, wherein the network node performs any of the operations of any of the Group B claims to transmit the user data from the host to the UE.
Embodiment 49. The method of the previous embodiment, further comprising, at the network node, transmitting the user data provided by the host for the UE.
Embodiment 50. The method of any of the previous 2 embodiments, wherein the user data is provided at the host by executing a host application that interacts with a client application executing on the UE, the client application being associated with the host application.
Embodiment 51. A communication system configured to provide an over-the-top service, the communication system comprising:
a host comprising:
processing circuitry configured to provide user data for a user equipment 120 (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B claims to transmit the user data from the host to the UE.
Embodiment 52. The communication system of the previous embodiment, further comprising:
the network node; and/or
the user equipment 120.
Embodiment 53. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment 120 (UE) for the host.
Embodiment 54. The host of the previous embodiment, wherein:
the processing circuitry of the host is configured to execute a host application, thereby providing the user data; and
the host application is configured to interact with a client application executing on the UE, the client application being associated with the host application.
Embodiment 55. The host of the any of the previous 2 embodiments, wherein the initiating receipt of the user data comprises requesting the user data.
Embodiment 56. A method implemented by a host configured to operate in a communication system that further includes a network node and a user equipment 120 (UE), the method comprising:
at the host, initiating receipt of user data from the UE, the user data originating from a transmission which the network node has received from the UE, wherein the network node performs any of the steps of any of the Group B claims to receive the user data from the UE for the host.
Embodiment 57. The method of the previous embodiment, further comprising at the network node, transmitting the received user data to the host.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
QoE Quality of Experience
SRB Signalling Radio Bearer
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1.-60. (canceled)

61. A method performed by a user equipment for handling Quality of Experience (QoE) configurations, the method comprises:
receiving, from a network node, a message including a request for full configuration;
sending one or more Attention (AT) commands from a Radio Resource Control (RRC) layer of the user equipment to an application layer of the user equipment, wherein the one or more AT commands include at least one of:
an indication to release all QoE configurations in an initial set following a mobility event;
an indication to not release any of the initial set of QoE configurations following a mobility event;
an indication to set the initial set of QoE configurations on hold;
a list of QoE configuration identifiers corresponding to one or more QoE configurations to be released by the user equipment following a mobility event; or
a list of QoE configuration identifiers corresponding to one or more QoE configurations to be retained by the user equipment following a mobility event if the received message includes the list of QoE configuration identifiers; and
performing one of the following based on the one or more AT commands:
setting the initial set of QoE configurations on hold in the application layer;
retaining the initial set of QoE configurations in the application layer; or
releasing one or more QoE configurations in the initial set of QoE configurations.

62. The method of claim 61, wherein releasing one or more QoE configurations in the initial set of QoE configurations is performed in the application layer.

63. The method of claim 61, wherein the one or more AT commands includes the list of QoE configuration identifiers corresponding to one or more QoE configurations to be retained, wherein releasing one or more QoE configurations in the initial set comprises releasing one or more QoE configurations that do not correspond to any one in the list of QoE configuration identifiers.

64. The method of claim 61, wherein the list of QoE configuration identifiers corresponding to one or more QoE configurations to be retained is empty, and wherein the one or more AT commands includes an indication to not release any of the initial set of QoE configurations.

65. The method of claim 61, wherein the message does not include a list of one or more QoE configurations to be retained by the user equipment, and the message further comprises a parameter indicating that no QoE configurations are to be released, and wherein the one or more AT commands includes an indication to not release any of the initial set of QoE configurations.

66. The method of claim 65, wherein the mobility event is a handover, or a resume event, or a reestablishment event, wherein the network node is a source network node, and wherein the parameter indicating that no QoE configurations are to be released further indicates that a target node supports the one or more QoE configurations that are supported by the source network node.

67. The method of claim 65, wherein the parameter comprises at least one of: a flag, a Boolean, and an ENUMERATED parameter.

68. The method of claim 61, wherein the message does not include a list of one or more QoE configurations to be retained by the user equipment, and wherein the one or more AT commands includes an indication to release all QoE configurations in the initial set or an indication to set the initial set of QoE configurations on hold.

69. The method of claim 68, wherein the mobility event is a handover, or a resume event, or a reestablishment event, wherein the network node is a source network node, and wherein the message further includes an indication that a target node does not support the one or more QoE configurations that are supported by the source network node.

70. The method of claim 61, wherein the message includes a list of QoE configuration identifiers corresponding to one or more QoE configurations to be retained, and the method further comprises, subsequent to one or more QoE configuration identifiers being deleted in the RRC layer as a result of the request for full configuration, restoring one or more QoE configuration identifiers at the RRC layer that correspond to the list of QoE configuration identifiers corresponding to one or more QoE configurations to be retained.

71. The method of claim 70, further comprising, subsequent to one or more QoE configurations being released in the RRC layer as a result of the request for full configuration: restoring one or more parameters associated with the one or more QoE configurations that correspond to the list of QoE configuration identifiers corresponding to one or more QoE configurations to be retained.

72. The method of claim 61, wherein the method comprises releasing one or more QoE configurations in the initial set of QoE configurations in the application layer, and wherein the method further comprises:
retaining, in the RRC layer, one or more QoE configurations at the RRC layer that corresponds to the initial set of QoE configurations subsequent to receiving the message including the request for full configuration; and
releasing one or more QoE configurations retained in the RRC layer that correspond to the one or more QoE configurations released in the application layer.

73. The method of claim 61, wherein a QoE configuration identifier is one of: a measConfigAppLayerId, a QoE reference, or a service type of the QoE measurement.

74. The method of claim 61, wherein the message is a RRCReconfiguration message.

75. The method of claim 61, wherein the mobility event is one of: a handover from the network node to a target network node, a RRC Resume event, a Reconfiguration with sync event, and a RRC Reestablishment event.

76. A user equipment for handling Quality of Experience (QoE) configurations, the user equipment comprising:
processing circuitry configured to cause the user equipment to:
receive, from a network node, a message including a request for full configuration;
send one or more Attention (AT) commands from a Radio Resource Control (RRC) layer of the user equipment to an application layer of the user equipment, wherein the one or more AT commands include at least one of:
an indication to release all QoE configurations in an initial set following a mobility event;
an indication to not release any of the initial set of QoE configurations following a mobility event;
an indication to set the initial set of QoE configurations on hold;
a list of QoE configuration identifiers corresponding to one or more QoE configurations to be released by the user equipment following a mobility event; or
a list of QoE configuration identifiers corresponding to one or more QoE configurations to be retained by the user equipment following a mobility event if the received message includes the list of QoE configuration identifiers; and
perform one of the following based on the one or more AT commands:
setting the initial set of QoE configurations on hold in the application layer;
retaining the initial set of QoE configurations in the application layer; or
releasing one or more QoE configurations in the initial set of QoE configurations; and
power supply circuitry configured to supply power to the processing circuitry.

77. The user equipment of claim 76, wherein the processing circuitry is configured perform, in the application layer, releasing of one or more QoE configurations in the initial set of QoE configurations.

78. The user equipment of claim 76, wherein the one or more AT commands includes the list of QoE configuration identifiers corresponding to one or more QoE configurations to be retained, wherein the processing circuitry is configured to release one or more QoE configurations in the initial set byte releasing one or more QoE configurations that do not correspond to any one in the list of QoE configuration identifiers.

79. The user equipment of claim 76, wherein the list of QoE configuration identifiers corresponding to one or more QoE configurations to be retained is empty, and wherein the one or more AT commands includes an indication to not release any of the initial set of QoE configurations.

80. The user equipment of claim 76, wherein the message does not include a list of one or more QoE configurations to be retained by the user equipment, and the message further comprises a parameter indicating that no QoE configurations are to be released, and wherein the one or more AT commands includes an indication to not release any of the initial set of QoE configurations.

81. The user equipment of claim 80, wherein the mobility event is a handover, or a resume event, or a reestablishment event, wherein the network node is a source network node, and wherein the parameter indicating that no QoE configurations are to be released further indicates that a target node supports the one or more QoE configurations that are supported by the source network node.

82. The user equipment of claim 80, wherein the parameter comprises at least one of: a flag, a Boolean, and an ENUMERATED parameter.

83. The user equipment of claim 76, wherein the message does not include a list of one or more QoE configurations to be retained by the user equipment, and wherein the one or more AT commands includes an indication to release all QoE configurations in the initial set or an indication to set the initial set of QoE configurations on hold.

84. The user equipment of claim 83, wherein the mobility event is a handover, or a resume event, or a reestablishment event, wherein the network node is a source network node, and wherein the message further includes an indication that a target node does not support the one or more QoE configurations that are supported by the source network node.

85. The user equipment of claim 76, wherein the message includes a list of QoE configuration identifiers corresponding to one or more QoE configurations to be retained, and the processing circuitry is further configured to, subsequent to one or more QoE configuration identifiers being deleted in the RRC layer as a result of the request for full configuration, restore one or more QoE configuration identifiers at the RRC layer that correspond to the list of QoE configuration identifiers corresponding to one or more QoE configurations to be retained.

86. The user equipment of claim 85, wherein the processing circuitry is further configured to, subsequent to one or more QoE configurations being released in the RRC layer as a result of the request for full configuration, restore one or more parameters associated with the one or more QoE configurations that correspond to the list of QoE configuration identifiers corresponding to one or more QoE configurations to be retained.
